(19) United States
(12) Patent Application Publication
(10) Pub. No.: US 2016/0075355 A1
(43) Pub. Date: Mar. 17, 2016

(54) SYSTEM AND METHOD FOR COMMUNICATION IN A VEHICLE CONSIST

(71) Applicant: General Electric Company, Schenectady, NY (US)

(72) Inventors: STEVEN ANDREW KELLNER, Melbourne, FL (US); ROBERT JAMES FOY, Melbourne, FL (US); ROBERT CARMEN PALANTI, Melbourne, FL (US); JARED KLINEMAN COOPER, Melbourne, FL (US); BRIAN WILLIAM SCHROECK, Melbourne, FL (US); PAUL AARON CONNOLLY, Erie, PA (US); ROBERT REPOLA, Fort Worth, TX (US)

(21) Appl. No.: 14/741,229

(22) Filed: Jun. 16, 2015

Related U.S. Application Data
(60) Provisional application No. 62/049,524, filed on Sep. 12, 2014.

(51) Int. Cl. B61L 23/00; B61L 25/02; G05D 1/00

(52) U.S. Cl. CPC B61L 23/00; G05D 1/0027; B61L 25/028

(57) ABSTRACT

Systems and methods for communicatively linking vehicles in a vehicle consist are provided. In one aspect, a lead vehicle can communicate a link command message to several remote vehicles. The link command message includes vehicle identifiers and/or a consist identifier. At the remote vehicles, if a vehicle identifier or a consist identifier stored onboard a remote vehicle matches the vehicle identifiers and/or consist identifier received in the link command message, the remote vehicle is communicatively linked with the lead vehicle to permit control of the remote vehicle by the lead vehicle. In another aspect, a vehicle identifier of the lead vehicle is stored onboard the remote vehicles. If the vehicle identifier stored on the remote vehicle matches a vehicle identifier received in the link command message, the remote vehicle is communicatively linked with the lead vehicle to permit control of the remote vehicle by the lead vehicle.

### CROSS-REFERENCE TO RELATED APPLICATIONS

This application claims priority to U.S. Provisional Application No. 62/049,524, which was filed on 12 Sep. 2014, and the entire disclosure of which is incorporated herein by reference.

### FIELD

Embodiments of the inventive subject matter described herein relate to communications between vehicles in a vehicle consist.

### BACKGROUND

Some known vehicle consists include several powered vehicles that generate tractive effort for propelling the vehicle consists along a route. For example, trains may have several locomotives coupled with each other that propel the train along a track. The locomotives may communicate with each other in order to coordinate the tractive efforts and/or braking efforts provided by the locomotives. As one example, locomotives may be provided in a distributed power (DP) arrangement with one locomotive designated as a lead locomotive and other locomotives designated as remote locomotives. The lead locomotive may direct the tractive and braking efforts provided by the remote locomotives during a trip of the consist.

Some known consists use wireless communication between the locomotives for coordinating the tractive and/or braking efforts. For example, a lead locomotive can issue commands to the remote locomotives. The remote locomotives receive the commands and implement the tractive efforts and/or braking efforts directed by the commands. In order to ensure that the remote locomotives receive the commands, the lead locomotive may periodically re-communicate the commands until all of the remote locomotives confirm receipt of the commands by communicating a confirmation message to the lead locomotive.

In order to set up the consists to wirelessly communicate in this manner, an operator typically travels to and boards each individual remote locomotive in turn. While onboard each remote locomotive, the operator enters a road number of the lead locomotive and an orientation of the remote locomotive relative to the lead locomotive in order to link the remote locomotive with the lead locomotive. This process is time consuming and prone to human error.

### BRIEF DESCRIPTION

In one embodiment, a method (e.g., for establishing a communication link between vehicles) includes receiving a link command message at a first remote vehicle in a vehicle consist having a lead vehicle and at least the first remote vehicle. The link command message includes identifying information representative of at least one of a designated vehicle consist or one or more designated remote vehicles. The method also includes comparing, onboard the first remote vehicle, the identifying information of the link command message with one or more of a stored consist identifier or a stored vehicle identifier stored onboard the first remote vehicle, and establishing a communication link between the lead vehicle and the first remote vehicle responsive to the identifying information of the link command message matching the one or more of the stored consist identifier or the stored vehicle identifier.

In another embodiment, a system (e.g., a communication system onboard a vehicle) includes a remote communication unit and a control unit. The remote communication unit is configured to receive a link command message at a first remote vehicle in a vehicle consist having a lead vehicle and at least the first remote vehicle. The link command message includes identifying information representative of at least one of a designated vehicle consist or one or more designated remote vehicles. The control unit is configured to be disposed onboard the first remote vehicle and to compare the identifying information of the link command message with one or more of a stored consist identifier or a stored vehicle identifier stored onboard the first remote vehicle. The control unit also configured to establish a communication link between the lead vehicle and the first remote vehicle responsive to the identifying information of the link command message matching the one or more of the stored consist identifier or the stored vehicle identifier.

In another embodiment, another method (e.g., for establishing a communication link between vehicles) includes obtaining a lead vehicle identifier onboard a remote vehicle in a vehicle consist having a first lead vehicle and at least the remote vehicle, receiving a link command message at the remote vehicle, the link command message including identifying information representative of a designated lead vehicle, comparing, onboard the remote vehicle, the identifying information of the link command message with the lead vehicle identifier, and establishing a communication link between the first lead vehicle and the remote vehicle responsive to the identifying information of the link command message matching the lead vehicle identifier.

In another embodiment, a system (e.g., a communication system onboard a vehicle) includes a control unit and a remote communication unit. The control unit is configured to be disposed onboard a remote vehicle in a vehicle consist having a first lead vehicle and at least the remote vehicle. The control unit also is configured to obtain a lead vehicle identifier representative of the first lead vehicle. The remote communication unit is configured to be disposed onboard the remote vehicle and to receive a link command message that includes identifying information representative of a designated lead vehicle. The control unit is configured to compare the identifying information of the link command message with the lead vehicle identifier and to establish a communication link between the first lead vehicle and the remote vehicle responsive to the identifying information of the link command message matching the lead vehicle identifier.

In another embodiment, a system (e.g., a communication system) includes a communication unit and a control unit. The communication unit can be configured to be disposed on one of onboard a lead vehicle of a vehicle consist having the lead vehicle and plural remote vehicles or off-board the vehicle consist. The control unit can be configured to be disposed on said one of onboard the lead vehicle or off-board the vehicle consist and to control the communication unit to transmit plural link command messages to the plural remote vehicles. Each of the link command messages can include identifying information representative of at least one of a designated vehicle consist and/or one or more designated remote vehicles. The control unit also can be configured to automatically establish one or more communication links with the remote vehicles responsive to the identifying information in the link command messages matching one or more of a stored consist identifier and/or a stored vehicle identifier stored onboard the remote vehicles.

### BRIEF DESCRIPTION OF THE DRAWINGS

Reference is now made briefly to the accompanying drawings, in which:

FIG. 1 is a schematic view of one embodiment of a communication system of a vehicle consist or vehicle system;

FIG. 2 illustrates a flowchart of one embodiment of a method for communicatively coupling vehicles in the vehicle consist shown in FIG. 1;

FIG. 3 illustrates a flowchart of another embodiment of a method for communicatively coupling vehicles in the vehicle consist shown in FIG. 1; and

FIG. 4 is a schematic diagram of a propulsion-generating vehicle in accordance with one embodiment.

### DETAILED DESCRIPTION

One or more embodiments of the inventive subject matter described herein provides for methods and systems for establishing communication links between propulsion-generating vehicles in a vehicle system that includes two or more of the propulsion-generating vehicles coupled with each other. For example, embodiments of the inventive subject matter may be used in connection with rail vehicles and rail vehicle consists, or other types of vehicles. In one aspect, remote propulsion-generating vehicles are configured to receive a wireless link command message from one or more lead propulsion-generating vehicles, as long as the link command message includes a remote vehicle identifier (e.g., a road number), or the identifier and name of the remote vehicle. The link command message optionally can include the orientation of the remote vehicle relative to the lead vehicle, such as facing the same direction or facing opposite directions. The lead vehicle can send (e.g., broadcast) a link command message that includes the remote vehicle identifiers of one or more remote vehicles that are to be included in the same vehicle consist as the lead vehicle. Optionally, this link command message can include the name of the vehicle consist and/or the orientation of the remote vehicle relative to the lead vehicle. Each of the remote vehicles that receive the link command message can examine the link command message to determine if the link command message includes a remote vehicle identifier that matches the identifier of the remote vehicle and/or a consist name that matches a designated consist name stored at the remote vehicle. If the identifiers and/or consist names match, then the remote vehicle may establish a communication link with the lead vehicle. For example, the remote vehicle may communicate a link reply message to the lead vehicle (to confirm receipt of the link command message) and begin accepting command messages from the lead vehicle that cause the remote vehicle to change operational settings (e.g., throttle settings, brake settings, etc.) where, prior to establishing the communication link, the remote vehicle would not accept and operate according to such command messages. The remote vehicle optionally may take the orientation included in the link command message and use this orientation to determine how to operate according to the command messages received from the lead vehicle.

In another embodiment, the remote vehicles may each be configured to store a lead vehicle identifier onboard the remote vehicles. This identifier can represent which of several different lead vehicles that the remote vehicle can receive command messages from and operate according to. The lead vehicle may then send (e.g., broadcast) a link command message that includes the lead vehicle identifier. This message may not include the consist name and/or the identifiers of the remote vehicles. Alternatively, the message may include the consist name and/or the identifier of one or more of the remote vehicles. Upon receipt of the command link message at the remote vehicles, the remote vehicles can communicate link reply messages to the lead vehicle to establish communication links with the lead vehicle. Establishing the communication links between the lead and remote vehicles according to one or more embodiments descried herein can reduce the amount of time needed to prepare the consist for travel by eliminating some travel of an operator to the remote vehicles to set the remote vehicles up for distributed power operations. Additionally, human error in setting up the vehicles can be reduced by reducing the number of times the operator has to input identifiers, consist names, or the like.

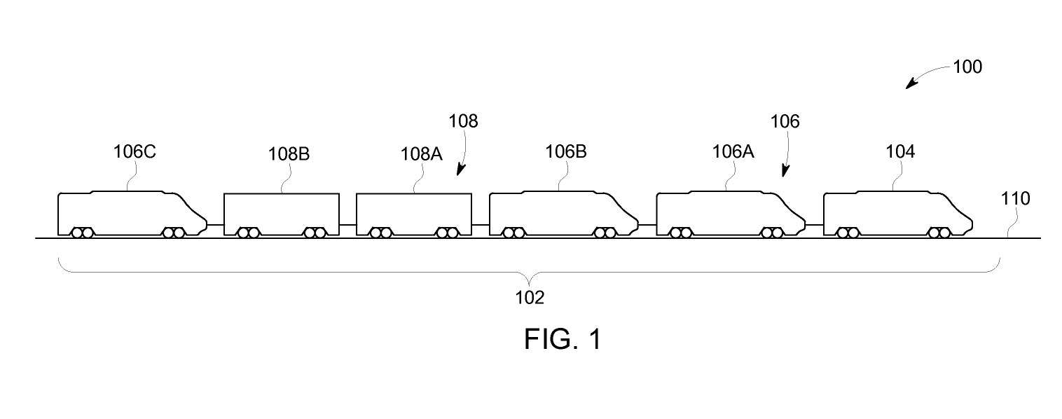

FIG. 1 is a schematic view of one embodiment of a communication system 100 of a vehicle consist or vehicle system 102. The illustrated vehicle consist 102 includes propulsion-generating vehicles 104, 106 (e.g., vehicles 104, 106A, 106B, 106C) and non-propulsion-generating vehicles 108 (e.g., vehicles 108A, 108B) mechanically coupled with each other. The propulsion-generating vehicles are capable of self-propulsion while the non-propulsion-generating vehicles are not capable of self-propulsion. The propulsion-generating vehicles 104, 106 are shown as locomotives, the non-propulsion-generating vehicles 108 are shown as rail cars, and the vehicle consist 102 is shown as a train in the illustrated embodiment. Alternatively, the vehicles 104, 106 may represent other vehicles, such as automobiles, marine vessels, or the like, and the vehicle consist 102 can represent a grouping or coupling of these other vehicles. In one embodiment, the vehicles 104, 106 may not be mechanically coupled with each other. For example, the vehicles 104, 106 may be separate from each other, but may communicate with each other to coordinate operations of the vehicles 104, 106. For example, the vehicle 104 may wirelessly communicate operational command messages to the vehicles 106 that remotely control or direct operational settings of the vehicles 106 so that the vehicles 104, 106 can remain designated distances from each other or otherwise travel together. The number and arrangement of the vehicles 104, 106 in the vehicle consist 102 are provided as one example and are not intended as limitations on all embodiments of the inventive subject matter described herein.

The vehicles 104, 106 can be arranged in a distributed power (DP) arrangement. For example, the vehicles 104, 106 can include a lead vehicle 104 that issues command messages to the other vehicles 106A, 106B, 106C which are referred to herein as remote vehicles. The designations “lead” and “remote” are not intended to denote spatial locations of the vehicles 104, 106 in the vehicle consist 102, but instead are used to indicate which vehicle 104, 106 is communicating (e.g., transmitting, broadcasting, or a combination of transmitting and broadcasting) operational command messages and which vehicles 104, 106 are being remotely controlled using the operational command messages. For example, the lead vehicle 104 may or may not be disposed at the front end of the vehicle consist 102 (e.g., along a direction of travel of the vehicle consist 102). Additionally, the remote vehicles 106A-C need not be separated from the lead vehicle 104. For example, a remote vehicle 106A-C may be directly coupled with the lead vehicle 104 or may be separated from the lead vehicle 104 by one or more other remote vehicles 106A-C and/or vehicles 108.

The operational command messages may include directives that direct operations of the remote vehicles. These directives can include propulsion commands that direct propulsion subsystems of the remote vehicles to move at a designated speed and/or power level, brake commands that direct the remote vehicles to apply brakes at a designated level, and/or other commands. The lead vehicle 104 issues the command messages to coordinate the tractive efforts and/or braking efforts provided by the vehicles 104, 106 in order to propel the vehicle consist 102 along a route 110, such as a track, road, waterway, or the like.

The operational command messages can be communicated using the communication system 100, as described below. In one embodiment, the operational command messages are wirelessly communicated using the communication system 100. Prior to communicating the operational command messages, the vehicles 104, 106 may need to be communicatively coupled with each other. For example, one or more communication links may need to be established between the vehicles 104, 106 before the vehicles 106 will operate according to the operational command messages. A communication link may be established between the lead vehicle 104 and the remote vehicle 106 responsive to a link command message being communicated between the vehicles 104, 106 that correctly identifies the other of the vehicles 104, 106 (e.g., the message identifies the vehicle 104, 106 that is sending the message and/or the vehicle 104, 106 that is receiving the message) and the vehicle 104, 106 that receives the link command message communicating a reply link message to confirm receipt of the link command message.

The messages can identify the vehicles 104, 106 by a vehicle identifier. The vehicle identifier can represent a unique numeric and/or alphanumeric sequence or code that distinguishes one vehicle 104, 106 from other vehicles 104, 106. Alternatively, a vehicle identifier may identify two or more vehicles 104, 106 differently from one or more other vehicles 104, 106. For example, a vehicle identifier can represent a type of vehicle, a group of vehicles, or the like.

Optionally, the messages may identify vehicles 104, 106 by a consist name. A consist name can represent a unique numeric and/or alphanumeric sequence or code that distinguishes one vehicle consist 102 from other vehicle consists 102. For example, in a vehicle yard such as a rail yard, several vehicle consists 102 may be relatively close to each other such that the vehicles 104, 106 in the different vehicle consists 102 are able to wirelessly communicate with each other. To prevent the vehicles 104, 106 in one vehicle consist 102 from mistakenly communicating with a vehicle 104, 106 in another vehicle consist 102 (e.g., such as by operating according to operational command messages from another vehicle consist 102), the messages optionally may include a consist name to identify which vehicle consist 102 that the messages are associated with.

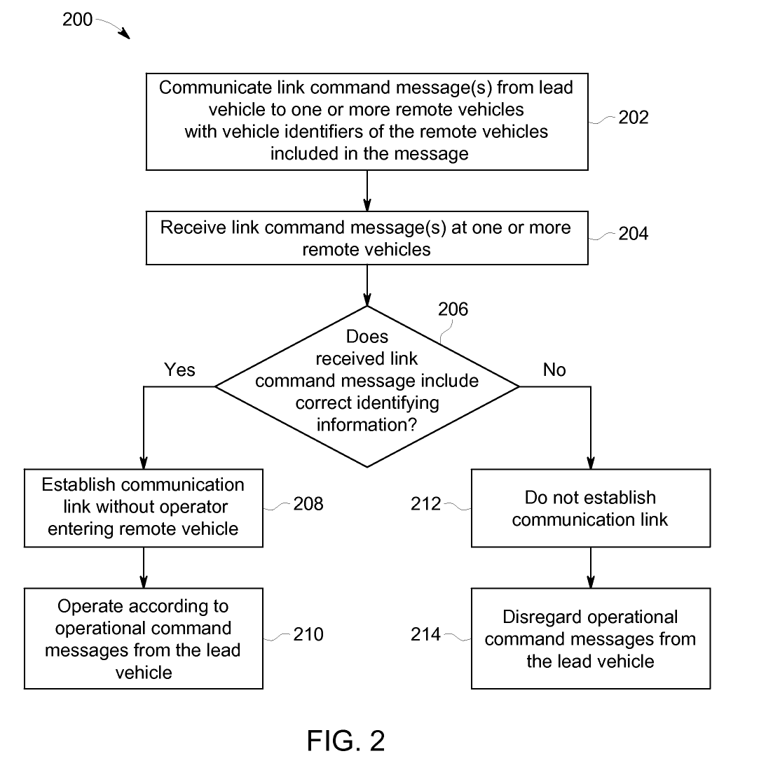

FIG. 2 illustrates a flowchart of one embodiment of a method 200 for communicatively coupling vehicles 104, 106 in the vehicle consist shown in FIG. 1. The method 200 may be used to establish communication links between the vehicles 104, 106 so that the lead vehicle 104 can coordinate tractive efforts and/or braking efforts provided by the vehicles 106. For example, the method 200 may be used to set up the vehicles 104, 106 to operate in a distributed power (DP) mode. The method 200 can be used to establish the communication links between the vehicles 104, 106 without an operator having to travel to and/or board the remote vehicles 106.

At 202, one or more link command messages are communicated to the remote vehicles 106. The link command message(s) may be broadcast from the lead vehicle 104 to the remote vehicles 106. Alternatively, the link command message(s) may be communicated from another source, such as a tower, a dispatch center, a remote control device (e.g., an operator control unit), or the like. The link command message(s) can be wirelessly transmitted and/or broadcast. Prior to communicating the link command message(s), the vehicles 104, 106 may not be communicatively coupled. For example, the vehicles 106 may not be set up to operate according to operational command messages received from the lead vehicle 104.

The link command message(s) include a vehicle identifier of one or more of the remote vehicles 106. For example, the link command message(s) can include unique identifiers of the plural remote vehicles 106 that are to be included in the vehicle consist 102. Alternatively, each of the link command messages can include a single vehicle identifier of a single remote vehicle 106 that is to be included in the vehicle consist 102. Several link command messages may be sent with each link command message identifying another remote vehicle 106 so that several remote vehicles 106.

In one embodiment, the link command message(s) can include a vehicle consist identifier. For example, the link command message(s) can include the vehicle identifiers of the remote consists 106 that are to be communicatively linked with the lead vehicle 104 and the vehicle consist identifier of the vehicle consist 102 that will include the vehicles 104, 106. Alternatively, the link command message(s) may include the vehicle consist identifier and not the vehicle identifiers of the remote vehicles 106.

At 204, the link command message(s) are received at the remote vehicles 106. In one aspect, the link command message(s) may be received by the remote vehicles 106 that are to be included in the vehicle consist 102 and one or more other remote vehicles that are not to be included in the vehicle consist 102. For example, due to the close proximity between several vehicle consists 102, the remote vehicles 106 in one or more other vehicle consists may receive the link command message(s) for the vehicle consist 102 shown in FIG. 1. As a result, both the remote vehicles 106 in the vehicle consist 102 and the remote vehicles 106 that are not in the vehicle consist 102 may wirelessly receive the link command message(s). Alternatively, the link command message may only be received by the remote vehicles 106 that are in the vehicle consist 102.

At 206, the link command message is examined to determine if the link command message includes correct identifying information. For example, in response to receiving the link command message at a remote vehicle 106, the remote vehicle 106 can parse the link command message to determine if the link command message includes one or more types of identifying information that identifies the remote vehicle 106 and/or the vehicle consist 102. The vehicle identifiers and/or consist identifiers can be stored onboard the remote vehicles 106, such as in memories, control units, or the like, of the remote vehicles 106.

If the link command message includes the correct identifying information, then the remote vehicle 106 can determine that the remote vehicle 106 can communicatively link with the lead vehicle 104 to receive operational command messages from the lead vehicle 104. As a result, flow of the method 200 can proceed to 208. On the other hand, if the link command message does not include the correct identifying information, then the remote vehicle 106 can determine that the remote vehicle 106 cannot communicatively link with the lead vehicle 104 to receive operational command messages from the lead vehicle 104. As a result, flow of the method 200 can proceed to 212. The determination performed at 206 can be performed onboard each of the remote vehicles 106 without an operator being onboard the remote vehicles 106.

In one aspect, the identifying information in the link command message is correct when the link command message includes the vehicle identifier of the remote vehicle 106 and the consist identifier stored onboard the remote vehicle 106. For example, if the link command message includes one or more vehicle identifiers, and at least one of the vehicle identifiers matches or otherwise corresponds to the vehicle identifier of the remote vehicle 106 that received the link command message, then the link command message includes the correct vehicle identifier for that remote vehicle 106. If the link command message includes a consist identifier that matches or otherwise corresponds to a consist identifier stored onboard the remote vehicle 106, then the link command message includes the correct consist identifier for that remote vehicle 106. If either the vehicle identifier or the consist identifier in the link command message does not match or otherwise correspond to the vehicle identifier of the remote vehicle 106 or the consist identifier stored onboard the remote vehicle 106 that receives the link command message, then the identifying information in the link command message is not correct. Alternatively, the identifying information may be correct if the link command message includes the vehicle identifier of the remote vehicle 106. For example, the link command message may not include the consist identifier of the vehicle consist 102.

The link command message optionally can include an orientation identification of the remote vehicle 106. The orientation identification indicates the orientation of the remote vehicle 106 relative to the lead vehicle 104. For example, the vehicles 104, 106 may be facing different directions, which can be referred to as “short hood forward,” “long hood forward,” forward, backward, or the like. Depending on whether the remote vehicle 106 that is to be communicatively linked with the lead vehicle 104 is facing the same or opposite direction of the lead vehicle 104, operational settings that are communicated to the remote vehicle 106 by operational command messages from the lead vehicle 104 may be implemented differently. For example, the direction in which the remote vehicle 106 is to rotate wheels of the remote vehicle 106 may change based on whether the remote vehicle 106 is facing the same or opposite direction of the lead vehicle 104 in order to avoid stretching or compressing the vehicle consist 102. The link command message can include the orientation of the remote vehicle 106 relative to the lead vehicle 102 so that an operator does not need to travel to the remote vehicle 106 and manually provide this information onboard the remote vehicle 106.

At 208, a communication link between the remote vehicle 106 and the lead vehicle 104 is established. As described above, because the link command message includes the correct identifying information, the remote vehicle 106 that received and examined the identifying information can be communicatively linked with the lead vehicle 104 in order to be remotely controlled by the lead vehicle 104 without an operator having to travel to and go onboard the remote vehicle 106. The examination of the link command message and the establishment of the communication link at 206 and 208 can be performed for each of the remote vehicles 106 (or at least one or more of the remote vehicles 106) that is included in the vehicle consist 102.

At 210, the remote vehicle 106 that is communicatively linked with the lead vehicle 104 operates according to operational command messages communicated from the lead vehicle 104. For example, the lead vehicle 104 may broadcast operational command messages that include operational settings (e.g., throttle settings, brake settings, or the like) for the remote vehicles 106 in the vehicle consist 102. The operational command messages may be received by remote vehicles 106 that are included in the vehicle consist 102 and by other remote vehicles that are not included in the vehicle consist 102. The remote vehicles 106 that are in the vehicle consist 102 are communicatively linked with the lead vehicle 104 and use the operational settings in the received operational command messages to control movement of the remote vehicles 106. The remote vehicles that are not in the vehicle consist 102 are not communicatively linked with the lead vehicle 104 and disregard the operational command messages.

In one embodiment, an operator onboard the lead vehicle 104 may initiate a test message to verify that the remote vehicles 106 are communicatively linked with the lead vehicle 104 prior to the lead vehicle 104 remotely controlling movement of the remote vehicles 106. For example, the lead vehicle 104 may reduce fluid pressure in a brake system of the vehicle system (e.g., reduce the air pressure in an air brake pipe). This reduction in fluid can propagate through one or more conduits to the brake pipes in the remote vehicles 106. The remote vehicles 106 can communicate the reduction in pressure in the brake pipes and/or the rate at which fluid (e.g., air) is flowing through the brake pipes to the lead vehicle 104. The lead vehicle 104 can use the communicated reduction in pressure and/or airflow from the remote vehicles 106 as confirmation that the remote vehicles 106 are communicatively linked with the lead vehicle 104. If no such reduction in pressure and/or airflow from a remote vehicle 106 is received at the lead vehicle 104, then the lead vehicle 104 can determine that the remote vehicle 106 is not communicatively linked with the lead vehicle 104. Alternatively, the test message may be initiated automatically (e.g., without operator action). For example, following an attempted linking of the lead and remote vehicles, the control unit 402 and/or communication unit 410 can automatically direct the brake system to reduce the fluid pressure as the test message.

Returning to the description of the determination made at 206, if the link command message does not include the correct identifying information, then flow of the method 200 proceeds to 212. At 212, a communication link is not established between the remote vehicle (that received the link command message having the incorrect identifying information) and the lead vehicle 104. For example, because the remote vehicle is not in the vehicle consist 102, the remote vehicle may have a different vehicle identifier and/or consist identifier that does not match the identifying information in the link command message. As a result, the remote vehicle 106 is not communicatively linked with the lead vehicle 104.

At 214, the remote vehicle disregards operational command messages received from the lead vehicle 104. For example, because the link command message did not include identifying information that corresponded to the remote vehicle, the remote vehicle disregards operational command messages received from the lead vehicle 104.

As described herein, the method 200 may be used to establish communication links between the vehicles 104, 106 in the vehicle consist 102 without an operator having to travel to and board the remote vehicles 106. In another embodiment, however, the vehicles 104, 106 can be communicatively linked with a process that involves the operator traveling to the remote vehicles 106. The method 200 can save time in setting up the vehicle consist 102 by potentially eliminating the need for an operator to travel to and board the remote vehicles 106 to set up the remote vehicles 106 for DP operations. Additionally, the method 200 can reduce human error by reducing the number of times that the operator has to enter the identifying information into control units, memories, or the like, of the vehicles 104, 106. Human error of this type can result in communication link failures and additional time required to diagnose the failures and then to properly set up the vehicles 104, 106.

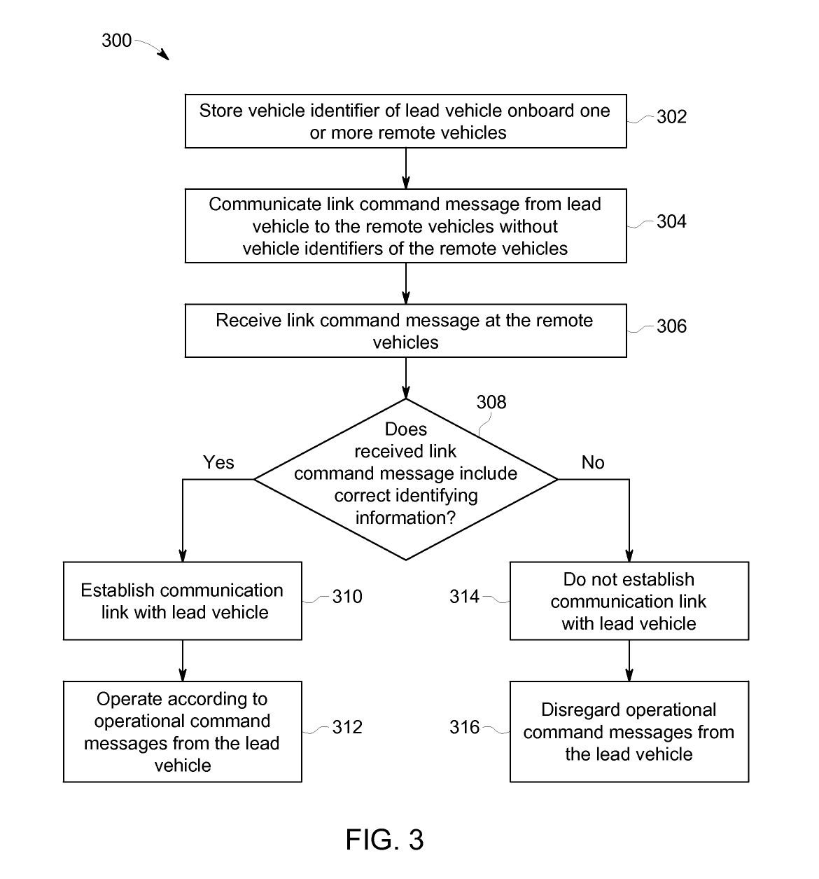

FIG. 3 illustrates a flowchart of another embodiment of a method 300 for communicatively coupling vehicles 104, 106 in the vehicle consist 102 shown in FIG. 1. The method 300 may be used to establish communication links between the vehicles 104, 106 so that the lead vehicle 104 can coordinate tractive efforts and/or braking efforts provided by the vehicles 106. For example, the method 300 may be used to set up the vehicles 104, 106 to operate in the DP mode.

At 302, a vehicle identifier of the lead vehicle 104 is provided to one or more (or all) of the remote vehicles 106. For example, an operator can travel to and go onboard the remote vehicles 106 and input the vehicle identifier of the lead vehicle 104 into control units, memories, or the like, of the remote vehicles 106. The remote vehicles 106 can store the vehicle identifier in the onboard memories, control units, or the like. Alternatively, the vehicle identifier of the lead vehicle 104 may be communicated to the remote vehicles 106, such as by communicating the vehicle identifier via, over, through, or otherwise using one or more conductive pathways that connect the lead vehicle 104 and the remote vehicles 106 (e.g., a multiple unit cable, train line, brake line, or other cable or bus) or wirelessly communicating the vehicle identifier. The vehicle identifier of the lead vehicle 104 that is provided to the remote vehicle 106 can be referred to as a stored vehicle identifier, a designated vehicle identifier, a lead vehicle identifier, or the like. Optionally, the vehicle identifier may be automatically communicated to the remote vehicles 106, such as by the control unit 402 and/or communication unit 410 sending the vehicle identifiers without any action on the part of the operator.

At 304, a link command message is communicated to the remote vehicles 106. The link command message may be broadcast from the lead vehicle 104 to the remote vehicles 106. Alternatively, the link command message may be communicated from another source, such as a tower, a dispatch center, a remote control device (e.g., an operator control unit), or the like. The link command message can be wirelessly transmitted and/or broadcast. Prior to communicating the link command message, the vehicles 104, 106 may not be communicatively coupled. For example, the vehicles 106 may not be set up to operate according to operational command messages received from the lead vehicle 104. The link command message includes the vehicle identifier of the lead vehicle 104. For example, in contrast to the link command message communicated at 202 in the flowchart of the method 200 shown in FIG. 2, the link command message that is communicated to the remote vehicles 106 at 304 may include the vehicle identifier of the lead vehicle 104, but not of the remote vehicles 106.

At 306, the link command message is received at the remote vehicles 106. As described above, the link command message may be received by the remote vehicles 106 that are to be included in the vehicle consist 102 and one or more other remote vehicles that are not to be included in the vehicle consist 102.

At 308, the link command message is examined to determine if the link command message includes correct identifying information. For example, in response to receiving the link command message at a remote vehicle 106, the remote vehicle 106 can parse the link command message to determine if the link command message includes the vehicle identifier of the lead vehicle 104. The vehicle identifier that is included in and/or received at the remote vehicle 106 via the link command message may be referred to as a received vehicle identifier.

The remote vehicle 106 can compare the received vehicle identifier from the link command message with the stored vehicle identifier that previously was provided to the remote vehicle 106 at 302. If the received vehicle identifier and the stored vehicle identifier represent the same lead vehicle 104, then the remote vehicle 106 can determine that the remote vehicle 106 can communicatively link with the lead vehicle 104 to receive operational command messages from the lead vehicle 104. As a result, flow of the method 300 can proceed to 310. On the other hand, if the received vehicle identifier does not match the stored vehicle identifier, then the remote vehicle 106 can determine that the remote vehicle 106 cannot communicatively link with the lead vehicle 104 to receive operational command messages from the lead vehicle 104. As a result, flow of the method 300 can proceed to 314. The determination performed at 308 can be performed onboard each of the remote vehicles 106 without an operator being onboard the remote vehicles 106. For example, after the stored vehicle identifier is provided to the remote vehicles 106, the operator can return to the lead vehicle 104 to cause the lead vehicle 104 to communicate the link command message while the operator remains onboard the lead vehicle 104 and/or does not go back onboard one or more of the remote vehicles 106.

At 310, a communication link between the remote vehicle 106 and the lead vehicle 104 is established. The examination of the link command message and the establishment of the communication link at 308 and 310 can be performed for each of the remote vehicles 106 (or at least one or more of the remote vehicles 106) that is included in the vehicle consist 102. At 312, the remote vehicle 106 that is communicatively linked with the lead vehicle 104 operates according to operational command messages communicated from the lead vehicle 104. For example, the lead vehicle 104 may broadcast operational command messages that include operational settings (e.g., throttle settings, brake settings, or the like) for the remote vehicles 106 in the vehicle consist 102. The operational command messages may be received by remote vehicles 106 that are included in the vehicle consist 102 and by other remote vehicles that are not included in the vehicle consist 102. The remote vehicles 106 that are in the vehicle consist 102 are communicatively linked with the lead vehicle 104 and use the operational settings in the received operational command messages to control movement of the remote vehicles 106. The remote vehicles that are not in the vehicle consist 102 are not communicatively linked with the lead vehicle 104 and disregard the operational command messages.

In one embodiment, an operator onboard the lead vehicle 104 may initiate a test message to verify that the remote vehicles 106 are communicatively linked with the lead vehicle 104 prior to the lead vehicle 104 remotely controlling movement of the remote vehicles 106. For example, the lead vehicle 104 may reduce fluid pressure in a brake system of the vehicle system (e.g., reduce the air pressure in an air brake pipe). This reduction in fluid can propagate through one or more conduits to the brake pipes in the remote vehicles 106. The remote vehicles 106 can communicate the reduction in pressure in the brake pipes and/or the rate at which fluid (e.g., air) is flowing through the brake pipes to the lead vehicle 104. The lead vehicle 104 can use the communicated reduction in pressure and/or airflow from the remote vehicles 106 as confirmation that the remote vehicles 106 are communicatively linked with the lead vehicle 104. If no such reduction in pressure and/or airflow from a remote vehicle 106 is received at the lead vehicle 104, then the lead vehicle 104 can determine that the remote vehicle 106 is not communicatively linked with the lead vehicle 104. Alternatively, the test message may be initiated automatically, as described herein.

Returning to the description of the determination made at 308, if the received vehicle identifier and the stored vehicle identifier do not represent the lead vehicle 104 (e.g., if the received vehicle identifier does not match or otherwise correspond with the stored vehicle identifier), then flow of the method 300 proceeds to 314. At 314, a communication link is not established between the remote vehicle (that received the link command message having the received vehicle identifier that does not match or otherwise correspond with the stored vehicle identifier) and the lead vehicle 104. For example, because the remote vehicle is not in the vehicle consist 102, the remote vehicle may have a different stored vehicle identifier than the vehicle identifier in the link command message. As a result, the remote vehicle 106 is not communicatively linked with the lead vehicle 104.

At 316, the remote vehicle disregards operational command messages received from the lead vehicle 104. For example, because the link command message did not include the vehicle identifier that matches the stored vehicle identifier, the remote vehicle disregards operational command messages received from the lead vehicle 104.

As described herein, the method 300 can reduce human error by reducing the number of times that the operator has to enter the identifying information into control units, memories, or the like, of the vehicles 104, 106. Human error of this type can result in communication link failures and additional time required to diagnose the failures and then to properly set up the vehicles 104, 106.

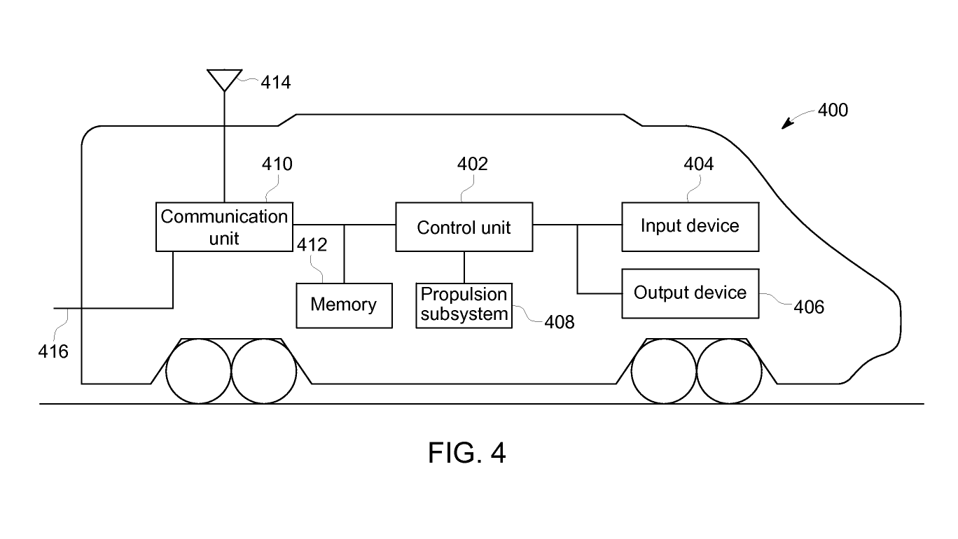

FIG. 4 is a schematic diagram of a propulsion-generating vehicle 400 in accordance with one embodiment. The vehicle 400 may represent one or more of the vehicles 104, 106 shown in FIG. 1. The vehicle 400 includes a communication system that includes a control unit 402 that controls operations of the vehicle 400. The control unit 402 can include or represent one or more hardware circuits or circuitry that include, are connected with, or that both include and are connected with one or more processors, controllers, or other hardware logic-based devices. The control unit 402 is connected with an input device 404 and an output device 406. The control unit 402 can receive manual input from an operator of the powered vehicle 400 through the input device 404, such as a touchscreen, keyboard, electronic mouse, microphone, or the like. For example, the control unit 402 can receive manually input changes to the tractive effort, braking effort, speed, power output, and the like, from the input device 404. The control unit 402 can present information to the operator using the output device 406, which can represent a display screen (e.g., touchscreen or other screen), speakers, printer, or the like. The control unit 402 can be used by an operator to input information into the vehicle 400, such as identifying information (e.g., stored vehicle identifiers, consist identifiers, orientations, or the like).

The control unit 402 can compare identifying information received via a link command message with identifying information stored onboard the vehicle 400 (e.g., in a memory 412 described below). For example, in a remote vehicle 106, the control unit 402 can compare a vehicle identifier received in a link command message with the vehicle identifier of the remote vehicle 106 to determine if the remote vehicle 106 can communicatively link with the lead vehicle 106. As another example, the control unit 402 can compare a consist identifier received in a link command message with the consist identifier stored in the remote vehicle 106 to determine if the remote vehicle 106 can communicatively link with the lead vehicle 106. As another example, the control unit 402 can compare a vehicle identifier received in a link command message with the stored vehicle identifier of the lead vehicle 106 that is stored onboard the remote vehicle 106 to determine if the remote vehicle 106 can communicatively link with the lead vehicle 106.

If the identifying information matches the information stored onboard the remote vehicle (as described above), the control unit 402 can establish a communication link with the lead vehicle 106. For example, the control unit 402 can begin receiving and operating according to operational command messages received from the lead vehicle 104 via the communication unit 410.

The control unit 402 is connected with a propulsion subsystem 408 of the powered vehicle 400. The propulsion subsystem 408 provides tractive effort and/or braking effort of the powered vehicle 400. The propulsion subsystem 408 may include or represent one or more engines, motors, alternators, generators, brakes, batteries, turbines, and the like, that operate to propel the powered vehicle 400 under the manual or autonomous control that is implemented by the control unit 400. For example, the control unit 400 can generate control messages autonomously or based on manual input that is used to direct operations of the propulsion subsystem 408.

The control unit 402 also is connected with the communication unit 410 and the memory 412 of the communication system in the powered vehicle 400. The memory 412 can represent an onboard device that electronically and/or magnetically stores data. For example, the memory 412 may represent a computer hard drive, random access memory, read-only memory, dynamic random access memory, an optical drive, or the like.

The communication unit 410 includes or represents hardware and/or software that is used to communicate with other vehicles 400 in the vehicle consist 102. For example, the communication unit 410 may include a transceiver 414 and associated circuitry for wirelessly communicating (e.g., communicating and/or receiving) command messages described above. Additionally or alternatively, the communication unit 410 include circuitry for communicating messages over a wired connection 416, such as a multiple unit (eMU) line of the vehicle consist 102 or another conductive pathway between or among the powered vehicles 104, 106, 400 in the vehicle consist 102. The control unit 402 may control the communication unit 410 by activating the communication unit 410 (as described above). The communication unit 410 can examine the messages that are received by the powered unit 400 as described above. For example, the communication unit 410 of a remote vehicle 106 can examine received command messages to determine the directive sent by the lead vehicle 104. The directive can be conveyed to the control unit 402, which then implements the directive by creating control messages that are communicated to the propulsion subsystem 408 for autonomous control or by presenting the directive to the operator on the output device 406 for manual implementation of the directive. The communication unit 410 can examine received messages sent by other vehicles 104, 106 to determine the identifying information in the messages. The communication unit 410 can store the received vehicle identifiers and other information and statuses in the memory 412.

In one embodiment, a method (e.g., for establishing a communication link between vehicles) includes receiving a link command message at a first remote vehicle in a vehicle consist having a lead vehicle and at least the first remote vehicle. The link command message can include identifying information representative of at least one of a designated vehicle consist and/or one or more designated remote vehicles. The method also can include comparing, onboard the first remote vehicle, the identifying information of the link command message with one or more of a stored consist identifier or a stored vehicle identifier stored onboard the first remote vehicle and establishing a communication link between the lead vehicle and the first remote vehicle responsive to the identifying information of the link command message matching the one or more of the stored consist identifier or the stored vehicle identifier.

In one aspect, the identifying information can include one or more of a unique vehicle identifier of the first remote vehicle or a unique consist identifier of the vehicle consist.

In one aspect, the identifying information in the link command message can include both the vehicle identifier and the consist identifier. The communication link can be established responsive to both the vehicle identifier in the link command message matching the stored vehicle identifier and the consist identifier matching the stored consist identifier.

In one aspect, the method also can include controlling movement of the first remote vehicle based on an operational command message received at the first remote vehicle from the lead vehicle over the communication link that is established where, prior to establishing the communication link, the first remote vehicle disregards the operational command message received from the lead vehicle.

In one aspect, the link command message also can include an orientation identification of the first remote vehicle relative to the lead vehicle.

In one aspect, the vehicle consist can include the lead vehicle and the at least the first remote vehicle mechanically separate from each other during remote control of movement of the at least the first remote vehicle by the lead vehicle.

In one aspect, the link command message can be communicated from the lead vehicle.

In another embodiment, a system (e.g., a communication system) includes a remote communication unit and a control unit. The a remote communication unit can be configured to receive a link command message at a first remote vehicle in a vehicle consist having a lead vehicle and at least the first remote vehicle. The link command message can include identifying information representative of at least one of a designated vehicle consist and/or one or more designated remote vehicles. The control unit can be configured to be disposed onboard the first remote vehicle and to compare the identifying information of the link command message with one or more of a stored consist identifier and/or a stored vehicle identifier stored onboard the first remote vehicle. The control unit also can be configured to establish a communication link between the lead vehicle and the first remote vehicle responsive to the identifying information of the link command message matching the one or more of the stored consist identifier or the stored vehicle identifier.

In one aspect, the identifying information can include one or more of a unique vehicle identifier of the first remote vehicle or a unique consist identifier of the vehicle consist.

In one aspect, the identifying information in the link command message can include both the vehicle identifier and the consist identifier. The control unit can be configured to establish the communication link responsive to both the vehicle identifier in the link command message matching the stored vehicle identifier and the consist identifier matching the stored consist identifier.

In one aspect, the control unit can be configured to control movement of the first remote vehicle based on an operational command message received at the first remote vehicle from the lead vehicle over the communication link. Prior to establishing the communication link, the control unit can disregard the operational command message received from the lead vehicle.

In one aspect, the link command message also can include an orientation identification of the first remote vehicle relative to the lead vehicle.

In one aspect, the vehicle consist can include the lead vehicle and the at least the first remote vehicle mechanically separate from each other during remote control of movement of the at least the first remote by the lead vehicle.

In one aspect, the communication unit can be configured to receive the link command message from the lead vehicle.

In another embodiment, a system (e.g., a communication system) includes a control unit and a remote communication unit. The control unit can be configured to be disposed onboard a remote vehicle in a vehicle consist having a first lead vehicle and at least the remote vehicle. The control unit also can be configured to obtain a lead vehicle identifier representative of the first lead vehicle. The remote communication unit can be configured to be disposed onboard the remote vehicle and to receive a link command message that includes identifying information representative of a designated lead vehicle. The control unit can be configured to compare the identifying information of the link command message with the lead vehicle identifier and to establish a communication link between the first lead vehicle and the remote vehicle responsive to the identifying information of the link command message matching the lead vehicle identifier.

In one aspect, the lead vehicle identifier can be a unique vehicle identifier of the first lead vehicle.

In one aspect, the control unit can be configured to control movement of the remote vehicle based on an operational command message received at the remote vehicle from the first lead vehicle over the communication link that is established. Prior to establishing the communication link, the control unit can be configured to disregard the operational command message received from the first lead vehicle.

In one aspect, the link command message also can include an orientation identification of the remote vehicle relative to the first lead vehicle.

In one aspect, the vehicle consist can include the first lead vehicle and the at least the remote vehicle mechanically coupled with each other.

In another embodiment, a system (e.g., a communication system) includes a communication unit and a control unit. The communication unit can be configured to be disposed on one of onboard a lead vehicle of a vehicle consist having the lead vehicle and plural remote vehicles or off-board the vehicle consist. The control unit can be configured to be disposed on said one of onboard the lead vehicle or off-board the vehicle consist and to control the communication unit to transmit plural link command messages to the plural remote vehicles. Each of the link command messages can include identifying information representative of at least one of a designated vehicle consist and/or one or more designated remote vehicles. The control unit also can be configured to automatically establish one or more communication links with the remote vehicles responsive to the identifying information in the link command messages matching one or more of a stored consist identifier and/or a stored vehicle identifier stored onboard the remote vehicles.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the inventive subject matter without departing from its scope. While the dimensions and types of materials described herein are intended to define the parameters of the inventive subject matter, they are by no means limiting and are exemplary embodiments. Many other embodiments will be apparent to one of ordinary skill in the art upon reviewing the above description. The scope of the inventive subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112(f), unless and until such claim limitations expressly use the phrase “means for” followed by a statement of function void of further structure.

This written description uses examples to disclose several embodiments of the inventive subject matter and also to enable one of ordinary skill in the art to practice the embodiments of inventive subject matter, including making and using any devices or systems and performing any incorporated methods. The patentable scope of the inventive subject matter is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

The foregoing description of certain embodiments of the present inventive subject matter will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (for example, processors or memories) may be implemented in a single piece of hardware (for example, a general purpose message processor, microcontroller, random access memory, hard disk, and the like). Similarly, the programs may be standalone programs, may be incorporated as subroutines in an operating system, may be functions in an installed software package, and the like. The various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the present inventive subject matter are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

What is claimed is:

1. A method comprising:
receiving a link command message at a first remote vehicle in a vehicle consist having a lead vehicle and at least the first remote vehicle, the link command message including identifying information representative of at least one of a designated vehicle consist or one or more designated remote vehicles;
comparing, onboard the first remote vehicle, the identifying information of the link command message with one or more of a stored consist identifier or a stored vehicle identifier stored onboard the first remote vehicle; and
establishing a communication link between the lead vehicle and the first remote vehicle responsive to the identifying information of the link command message matching the one or more of the stored consist identifier or the stored vehicle identifier.

2. The method of claim 1, wherein the identifying information includes one or more of a unique vehicle identifier of the first remote vehicle or a unique consist identifier of the vehicle consist.

3. The method of claim 2, wherein the identifying information in the link command message includes both the vehicle identifier and the consist identifier, and wherein the communication link is established responsive to both the vehicle identifier in the link command message matching the stored vehicle identifier and the consist identifier matching the stored consist identifier.

4. The method of claim 1, further comprising controlling movement of the first remote vehicle based on an operational command message received at the first remote vehicle from the lead vehicle over the communication link that is established, and
wherein, prior to establishing the communication link, the first remote vehicle disregards the operational command message received from the lead vehicle.

5. The method of claim 1, wherein the link command message also includes an orientation identification of the first remote vehicle relative to the lead vehicle.

6. The method of claim 1, wherein the vehicle consist includes the lead vehicle and the at least the first remote vehicle mechanically separate from each other during remote control of movement of the at least the first remote vehicle by the lead vehicle.

7. The method of claim 1, wherein the link command message is communicated from the lead vehicle.

8. A system comprising:
a remote communication unit configured to receive a link command message at a first remote vehicle in a vehicle consist having a lead vehicle and at least the first remote vehicle, the link command message including identifying information representative of at least one of a designated vehicle consist or one or more designated remote vehicles; and
a control unit configured to be disposed onboard the first remote vehicle and to compare the identifying information of the link command message with one or more of a stored consist identifier or a stored vehicle identifier stored onboard the first remote vehicle, the control unit also configured to establish a communication link between the lead vehicle and the first remote vehicle responsive to the identifying information of the link command message matching the one or more of the stored consist identifier or the stored vehicle identifier.

9. The system of claim 8, wherein the identifying information includes one or more of a unique vehicle identifier of the first remote vehicle or a unique consist identifier of the vehicle consist.

10. The system of claim 9, wherein the identifying information in the link command message includes both the vehicle identifier and the consist identifier, and wherein the control unit is configured to establish the communication link responsive to both the vehicle identifier in the link command message matching the stored vehicle identifier and the consist identifier matching the stored consist identifier.

11. The system of claim 8, wherein the control unit is configured to control movement of the first remote vehicle based on an operational command message received at the first remote vehicle from the lead vehicle over the communication link, and
wherein, prior to establishing the communication link, the control unit is configured to disregard the operational command message received from the lead vehicle.

12. The system of claim 8, wherein the link command message also includes an orientation identification of the first remote vehicle relative to the lead vehicle.

13. The system of claim 8, wherein the vehicle consist includes the lead vehicle and the at least the first remote vehicle mechanically separate from each other during remote control of movement of the at least the first remote by the lead vehicle.

14. The system of claim 8, wherein the communication unit is configured to receive the link command message from the lead vehicle.

15. A system comprising:
a control unit configured to be disposed onboard a remote vehicle in a vehicle consist having a first lead vehicle and at least the remote vehicle, the control unit also configured to obtain a lead vehicle identifier representative of the first lead vehicle; and
a remote communication unit configured to be disposed onboard the remote vehicle and to receive a link command message that includes identifying information representative of a designated lead vehicle, wherein the control unit is configured to compare the identifying information of the link command message with the lead vehicle identifier and to establish a communication link between the first lead vehicle and the remote vehicle responsive to the identifying information of the link command message matching the lead vehicle identifier.

16. The system of claim 15, wherein the lead vehicle identifier is a unique vehicle identifier of the first lead vehicle.

17. The system of claim 15, wherein the control unit is configured to control movement of the remote vehicle based on an operational command message received at the remote vehicle from the first lead vehicle over the communication link that is established, and
wherein, prior to establishing the communication link, the control unit is configured to disregard the operational command message received from the first lead vehicle.

18. The system of claim 15, wherein the link command message also includes an orientation identification of the remote vehicle relative to the first lead vehicle.

19. The system of claim 15, wherein the vehicle consist includes the first lead vehicle and the at least the remote vehicle mechanically coupled with each other.

20. A system comprising:
a communication unit configured to be disposed on one of onboard a lead vehicle of a vehicle consist having the lead vehicle and plural remote vehicles or off-board the vehicle consist; and
a control unit configured to be disposed on said one of onboard the lead vehicle or off-board the vehicle consist and to control the communication unit to transmit plural link command messages to the plural remote vehicles, each of the link command messages including identifying information representative of at least one of a designated vehicle consist or one or more designated remote vehicles, the control unit also configured to automatically establish one or more communication links with the remote vehicles responsive to the identifying information in the link command messages matching one or more of a stored consist identifier or a stored vehicle identifier stored onboard the remote vehicles.
